(19) United States
(12) Patent Application Publication
(10) Pub. No.: US 2024/0276161 A1
(43) Pub. Date: Aug. 15, 2024

(54) BINAURAL HEARING SYSTEM WITH TWO HEARING INSTRUMENTS AND METHOD FOR OPERATING SUCH A HEARING SYSTEM

(71) Applicant: Sivantos Pte. Ltd., Singapore (SG)

(72) Inventors: Eghart Fischer, Erlangen (DE); Cecil Wilson, Erlangen (DE); Sebastian Best, Erlangen (DE); Oliver Dressler, Erlangen (DE)

(21) Appl. No.: 18/417,317

(22) Filed: Jan. 19, 2024

(30) Foreign Application Priority Data
Jan. 19, 2023 (DE) 10 2023 200 405.4

(51) Int. Cl. H04R 25/00

(52) U.S. Cl. CPC H04R 25/552; H04R 25/505; H04R 2430/03

(57) ABSTRACT

A method for operating a binaural hearing system having first and second hearing instruments uses respective first and second input transducers to generate first and second input signals from an ambient sound. The first and second input signals are subjected to respective first and second low-latency analyses to determine at least one first and at least one second respective parameter of a signal processing. The first parameter is transmitted to the second hearing instrument and the second parameter is transmitted to the first hearing instrument. A synchronized parameter is determined in the first and second hearing instruments based on the first and second parameters. The synchronized parameter is applied in the first hearing instrument to signal components of the first input signal and in the second hearing instrument to signal components of the second input signal. A binaural hearing system is configured to carry out the method.

The invention relates to a binaural hearing system having two hearing instruments, which are to be worn in each case by a user on the left ear and right ear respectively. The invention furthermore relates to a method for operating such a hearing system.

A hearing instrument refers in general to an electronic device which assists the sense of hearing of a person wearing the hearing instrument (who is referred to hereinafter as the “wearer” or “user”). In particular, the invention relates to hearing instruments which are configured to entirely or partially compensate for hearing loss of a hearing-impaired user. Such a hearing instrument is also referred to as a “hearing aid”. In addition, there are hearing instruments which protect or improve the sense of hearing of users having normal hearing, for example, are to enable improved speech comprehension in complex hearing situations, or also in the form of communication devices (thus, for example, headsets or the like, possibly with earplug-shaped headphones).

Hearing instruments in general, and hearing aids especially, are usually designed to be worn on the head and here in particular in or on an ear of the user, in particular as behind-the-ear devices (also referred to as BTE devices from the English term “behind the ear”) or in-the-ear devices (also referred to as ITE devices from the English term “in the ear”). With regard to their internal structure, hearing instruments usually have at least one (acoustoelectrical) input transducer, a signal processing device (signal processor), and an output transducer. In operation of the hearing instrument, the or each input transducer records ambient sound and converts this ambient sound into a corresponding electrical input signal, the voltage variations of which preferably carry information on the oscillations of the air pressure induced in the air by the ambient sound. The or each input signal is processed (i.e., modified with respect to its sound information) in the signal processing device, in particular to assist the sense of hearing of the user, thus particularly preferably to compensate for hearing loss of the user. The signal processing device outputs a correspondingly processed audio signal as the output signal at the output transducer, which converts the output signal into an output sound signal. The output sound signal can consist here of airborne sound, which is emitted into the auditory canal of the user (possibly via a sound tube, as in a BTE device, or by appropriate positioning of the hearing instrument in the auditory canal). The output sound signal can also be emitted into the cranial bone of the user.

The term “binaural hearing system” refers to a system which comprises two hearing instruments in the above-mentioned sense, of which a first hearing instrument is used to treat the one ear of the user (for example the left ear) and is worn on or in this ear by the user in intended operation, while the second hearing instrument is used to treat the other ear of the user (for example the right ear) and is worn on or in this ear by the user in intended operation.

Algorithms for signal processing are implemented in each of the signal processing devices of the hearing instruments of a binaural hearing system. This comprises in particular that the respective input signals are analyzed in each hearing instrument, and parameter settings of the signal processing are performed on the basis of the analysis for each hearing instrument in order to treat a hearing difficulty of the user in the best possible manner in dependence on their audiological requirements (for example by amplification and/or compression by frequency band) or to otherwise assist the user in the best possible manner. In this way, however, problems can arise for the user in the localizing of sound sources, for example, if different signal amplifications are applied to the left and the right side.

The invention is therefore based on the object of specifying a method for operating a binaural hearing system, which enables a user of the binaural hearing system most precise possible localizing of sound sources with the most realistic possible hearing sensation. The invention is furthermore based on the object of specifying a binaural hearing system which is configured for carrying out such a method.

The first-mentioned object is achieved according to the invention by a method for operating a binaural hearing system having a first hearing instrument and a second hearing instrument, wherein the first hearing instrument has a first input transducer and the second hearing instrument has a second input transducer, wherein a first input signal is generated from an ambient sound by the first input transducer and a second input signal is generated from the ambient sound by the second input transducer, wherein the first input signal is subjected to a first low-latency analysis, and at least one first parameter of a signal processing is determined here, and wherein the second input signal is subjected to a second low-latency analysis, and a second parameter of a signal processing is determined here.

It is provided according to the method here that the first parameter is transmitted, in particular by the first hearing instrument, to the second hearing instrument, and the second parameter is transmitted, in particular by the second hearing instrument, to the first hearing instrument, that a synchronized parameter is determined in each case on the basis of the first parameter and the second parameter both in the first and in the second hearing instrument, preferably in the same manner, and that the synchronized parameter is applied in the first hearing instrument to signal components of the first input signal and is applied in the second hearing instrument to signal components of the second input signal. Advantageous embodiments or refinements of the invention, which are partially inventive viewed as such, are described in the dependent claims and the following description.

The first and second hearing instrument and the binaural hearing system are preferably of the type described at the outset here. The first or second input transducer comprises here any type of device which is configured to generate the respective electrical input signal from the ambient sound such that oscillations in the air pressure of the surroundings, which are caused by the sound, are represented by corresponding oscillations in the voltage and/or in the current of the relevant input signal. In particular, each of the two hearing instruments can have even further ones than the input transducers listed here, so that directional processing of multiple input signals generated in the hearing instrument is also possible locally in the relevant hearing instrument.

The binaural hearing system can optionally additionally also comprise at least one external electronic device, thus, for example, a remote control, a charger, or a programming device for one or both hearing instruments. In modern hearing systems, the remote control or the programming device is often implemented as a control program, in particular in the form of a so-called app, on a smartphone or tablet. The external device can be provided here independently of the hearing instruments and in particular by a different producer. However, the external device is a part of the binaural hearing system in the case in which, in conjunction with the two hearing instruments, it activates functions thereof or the like or coordinates their operation.

The processed first input signal, which is formed by the application of the synchronized parameter to the first input signal (and possibly still further local signal processing steps) can now preferably be converted in the first hearing instrument by an electroacoustic first output transducer into an output sound signal. This applies comparably to the processed second input signal. An (electroacoustic) output transducer comprises any device here which is provided and configured to convert an electrical signal into a corresponding sound signal, wherein voltage and/or current variations in the electrical signal are converted into corresponding amplitude variations of the sound signal, thus in particular a loudspeaker, a so-called balanced metal case receiver, but also a bone vibrator or the like.

A first low-latency analysis of the first input signal in particular comprises here an analysis in the time domain, and furthermore also an analysis in the time-frequency domain having a comparatively small number of frequency bands, for example, in comparison to a division of the first input signal into individual frequency bands taking place for other signal processing steps in the first hearing instrument, so that a lower latency is present in relation to such a division in the low-latency analysis. In the first low-latency analysis, at least one parameter of the signal processing for the first input signal is then determined (thus, for example, an amplification factor or a parameter of a compression (knee point, compression ratio, “attack”/“release” time constants, etc.)). The first analysis of the low-latency analysis can be carried out here, for example, according to specific properties of the first input signal such as level jumps or transients, on the basis of which said parameter is determined. This applies accordingly to the second low-latency analysis, wherein different algorithms can also be used for the first and the second low-latency analysis however (thus, for example, a first low-latency analysis in the time domain and a second low-latency analysis in the time-frequency domain having a small number of frequency bands), as long as the above-mentioned conditions are met.

The first parameter of the signal processing and the second parameter of the signal processing are now transmitted from the location of the generation (the first or second hearing instrument) to the respectively other hearing instrument, preferably by means of communication devices configured for this purpose (such as Bluetooth-capable or NFC-capable antennas in both hearing instruments or the like). The two said parameters preferably relate to the same signaling or physical variable (such as an amplification factor or a filter in the same frequency range or in at least partially overlapping frequency ranges), or at least permit conclusions about the same signaling or physical variable (such as signal level or a level peak in the same frequency range or in at least partially overlapping frequency ranges, on the basis of which further parameters of the signal processing such as an amplification factor can be derived in the respectively other hearing instrument).

The first parameter and the second parameter are now each present locally in the first and in the second hearing instrument. A synchronized parameter is now determined in each case in both hearing instruments both on the basis of the first parameter and on the basis of the second parameter. This preferably takes place in the same manner, i.e., in both hearing instruments on the basis of the same algorithm, i.e., the same mathematical function of the two parameters as function arguments is used in both hearing instruments, which maps these parameters on the synchronized parameter.

The synchronized parameter, which is now present locally in both hearing instruments with the same value as a result of the above-described generation, is now applied in the first hearing instrument to signal components of the first input signal and in the second hearing instrument to signal components of the second input signal, which preferably correspond to said signal components of the first input signal (thus, for example, to signal components in the same frequency bands) or were subjected to equivalent preprocessing. In particular, the signal components of the first or second input signal, to each of which the synchronized parameter is applied, can thus consist of signal components of one or more frequency bands or can be obtained therefrom, and/or the signal components of the first and second input signal can each be subjected together with signal components of further local signals in the first or second hearing instrument to local directional microphonics, so that the synchronized parameter is applied in each case to the signals resulting respectively in the first or second hearing instrument from the local directional microphonics.

Because the same parameter, namely the synchronized parameter, is now applied in each case in both hearing instruments to signal components corresponding to one another of the first and the second input signal or to signal components preprocessed in an equivalent manner of the first and the second input signal for the signal processing, natural (static) volume and dynamic differences between both sides are retained. These differences are used by the human sense of hearing for the localizing of sound sources (together with time-of-flight differences), so that the spatial hearing sensation can be improved by the described application of the synchronized parameter to the two input signals in the different hearing instruments.

Because a low-latency analysis moreover takes place in each case in each hearing instrument in order to determine the first or second parameter (on the basis of which the synchronized parameter is determined), no noticeable delays occur for the application. Rather, unavoidable latencies in the provision of the signal components of the first or second input signal, to each of which the synchronized parameter is to be applied, can be used to have the low-latency analyses mentioned (and the provision of the synchronized parameter) run in parallel thereto, so that no further time delay occurs overall due to the proposed method.

It has proven to be advantageous if the first input signal is divided in a first main signal path into a plurality of frequency bands (thus in particular transformation in the time-frequency domain), and in this way frequency band components of the first input signal are generated, wherein the synchronized parameter is applied in the first main signal path to said frequency band components as signal components of the first input signal, or is applied to signal components derived from said frequency band components. The individual frequency band components are transformed (back), preferably by means of a synthesis filter bank, into the time domain after frequency-selective application of the synchronized parameter, and converted by the output transducer—possibly after further signal processing steps—into the output sound signal. Signal processing of the second input signal analogous thereto preferably takes place in the second hearing instrument. This enables a first latency in the decomposition of the first input signal into the plurality of frequency bands in the main signal path, a second latency of the second low-latency analysis of the second input signal for determining the second parameter, a transmission time-of-flight of the second parameter from the second to the first hearing instrument, and the determination of the synchronized parameter to be at least compensated for.

The first and/or second low-latency analysis is advantageously provided by an analysis in the time domain or is provided by an analysis in the frequency domain or in particular in the time-frequency domain with a smaller number of frequency bands than the plurality of frequency bands in the first main signal path or a corresponding second main signal path of the second hearing instrument. An analysis in the time domain may be implemented with particularly low latency. In the second-mentioned case, it is ensured via the mentioned numbers of frequency bands that the latency of the first or second low-latency analysis is less than the latency in the respective contralateral main signal path, to the signal components of which the synchronized parameter is to be applied in a number of frequency bands.

Preferably, a delay is applied between the reception of the second parameter of the second hearing instrument by the first hearing instrument and the application of the synchronized parameter to signal components of the first input signal. This is advantageous in particular if in the above-mentioned first main signal path, a first latency is greater than the sum of the second latency of the second low-latency analysis, the transmission time of the second parameter from the second to the first hearing instrument, and possibly a runtime of the algorithm for determining the synchronized parameter.

In an alternative, also advantageous embodiment, the number of the frequency bands of the second low-latency analysis is selected such that the second latency of the second low-latency analysis and the transmission time, and possibly also the runtime of an algorithm for determining the synchronized parameter (in particular if this runtime is not negligible), together correspond to the first latency of the division of the first input signal into the plurality of frequency bands in the first main signal path. In this way, the maximum possible frequency resolution with respect to time for the second analysis is achieved in view of the latency of the frequency band decomposition in the first main signal path, without inducing still further delays (in relation to the latency of the frequency band decomposition in the first main signal path). This preferably applies comparably to the latency of the first low-latency analysis (in a secondary signal path of the first hearing instrument); in particular, the latency of the first analysis is equal to the latency of the second analysis.

It has furthermore proven to be advantageous if the synchronized parameter is determined on the basis of the first parameter and the second parameter by means of a maximum value and/or by means of a minimum value and/or by means of averaging and/or by means of summation. These types of calculation may be implemented particularly easily, and moreover have a linear relationship between the two parameters and thus between the two hearing instruments.

In a further advantageous embodiment, a transient is detected in the first low-latency analysis and/or in the second low-latency analysis, wherein a preferably discrete and particularly preferably binary switching value for a level reduction in the first main signal path by a predetermined amount is determined on the basis of a detected transient as a first parameter or second parameter. In particular, here, the switching value is such that the level reduction in the main signal path only takes place if a transient is detected. A transient is to be understood here in particular as an impulse sound, which has a level rising very rapidly in 8 comparison to other sound events, thus, for example, clattering or clinking cups, door slams, etc. The transient is preferably detected by means of an identification of a level increase of a predetermined minimum slope in this case in the first low-latency analysis or in the second low-latency analysis. In other words, it is checked whether, for example, over a specific small number of samples (for example preferably fewer than 25 samples, particularly preferably fewer than 10 samples) a predetermined level increase in dB is achieved (thus, for example, preferably by at least 10 dB, particularly preferably at least 20 dB). If this is the case in the first or second low-latency analysis, a switching value (in particular binary, thus 0 or 1) for a level reduction by a predetermined amount is determined as the first or second parameter of the signal processing, which is to be applied in the first main signal path and preferably also in the second main signal path to the signal components in the respective frequency bands. If a transient is present, the level reduction is applied (switching value 1), if no transient is present, no level reduction takes place (switching value 0).

The level reduction by the predetermined amount in the first main signal path in each of the plurality of frequency bands (and particularly preferably also in the second main signal path) preferably takes place here in addition on the basis of the respective signal components, i.e., for a low signal level in the respective frequency band, the level reduction can be applied to a lesser extent (starting from the predetermined amount as the base value) than for a higher signal level. In other words, the reduction by the predetermined amount can be implemented as the base value or “maximum reduction” in the form of a compression by frequency band.

The second-mentioned object is achieved according to the invention by a binaural hearing system, comprising a first hearing instrument having at least one first input transducer, and in particular having a first signal processing device, and furthermore comprising a second hearing instrument having at least one second input transducer and in particular having a second signal processing device, wherein the binaural hearing system is configured to carry out the method as claimed in any one of the preceding claims. In particular, the respective signal processing steps such as the first or second analysis of the relevant input signal and the determination of the synchronized parameter and the respective application thereof to the relevant signal components are carried out here in the first or second signal processing device.

The binaural hearing system according to the invention shares the advantages of the method according to the invention. The advantages specified for the method and for its refinements can be transferred accordingly to the binaural hearing system.

The first hearing instrument is preferably provided by a first local hearing aid and the second hearing instrument by a second local hearing aid, wherein the first local hearing aid and the second local hearing aid are each provided and configured to treat and in particular compensate for a hearing deficit or loss of hearing of the wearer.

An exemplary embodiment of the invention is explained in more detail hereinafter on the basis of drawings. In each of the schematic figures:

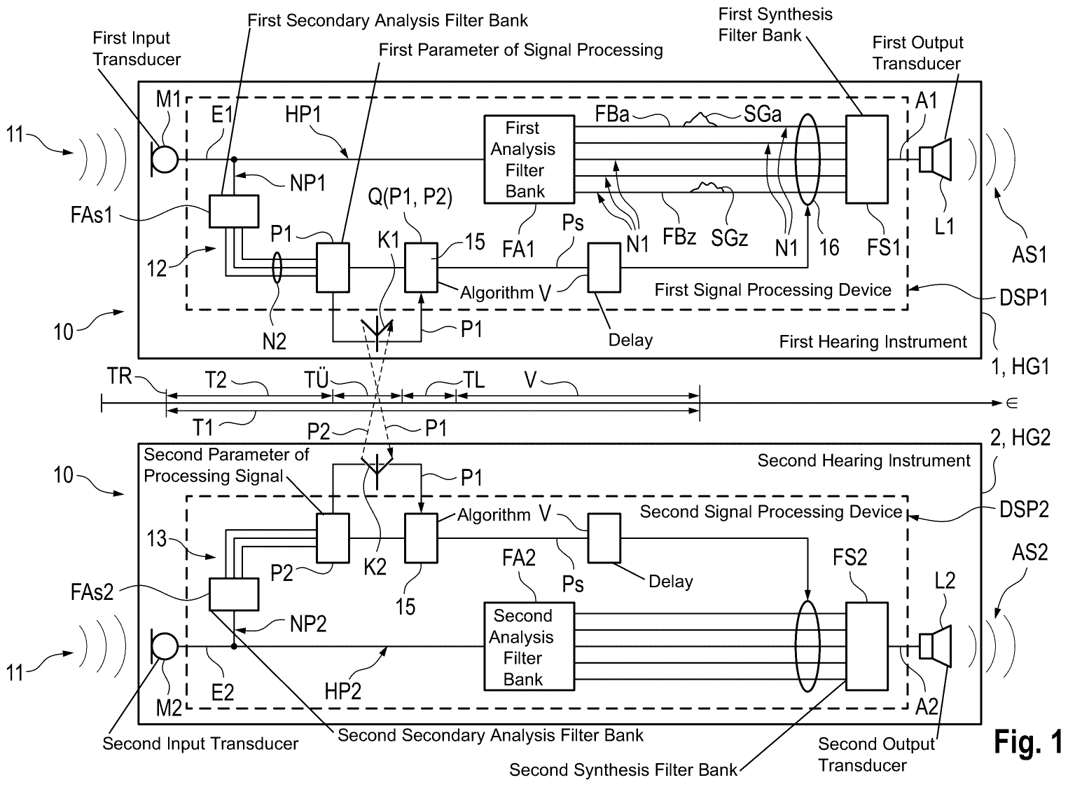

FIG. 1 shows a block diagram of a binaural hearing system in which local parameters of the signal processing are synchronized between the two hearing instruments, and

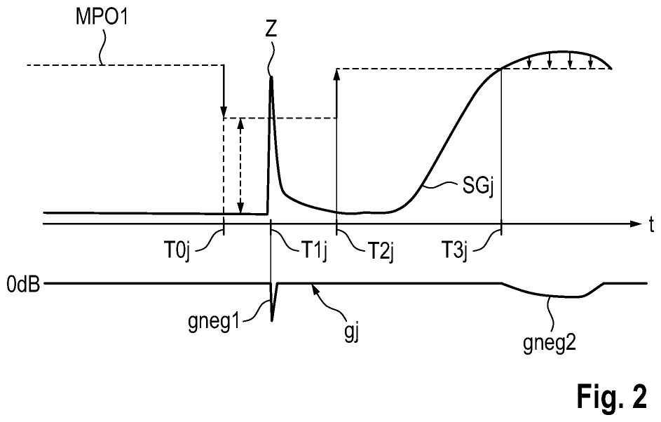

FIG. 2 shows the course of a signal level and signal processing, which is applied to the underlying input signal and is synchronized according 27 to FIG. 1, in a level diagram.

Parts and variables corresponding to one another are each provided with the same reference signs in all figures.

FIG. 1 schematically shows a block diagram of a binaural hearing system 10, which comprises a first hearing instrument 1 and a second hearing instrument 2. The signal flow from left to right in the hearing instruments is also plotted here against a corresponding timescale t. The first hearing instrument 1 is provided here by a first local hearing aid HG1, which is provided and configured to treat or at least partially correct a hearing deficit of a wearer (not shown in more detail), while the second hearing instrument 2 is provided here by a second local hearing aid HG2 having comparable properties. In particular, the first local hearing aid HG1 is designed and configured here to be worn on an ear (such as the left ear of the wearer), while the second local hearing aid HG2 is designed and configured to be worn on the other ear (such as the right ear of the wearer). The first and the second local hearing aid HG1, HG2 can be constructed essentially symmetrical to one another here (for example as respective BTE or ITE or RIC or CIC devices), and otherwise have structurally identical electronics (in particular identical signal processors).

The first hearing instrument 1 has an acoustoelectric first input transducer M1, which is provided in the present case by a microphone and is configured to generate a first input signal E1 from an ambient sound 11. The second hearing instrument 2 has an acoustoelectric second input transducer M2, which is also provided by a microphone and is configured to generate a second input signal E2 from the ambient sound 11. Preprocessing, which can in particular comprise pre-amplification and digitization, is already to take place in this case in the respective input transducers M1, M2, so that the input signals E1, E2 can be provided in particular by digital audio signals.

In the first hearing instrument 1, the first input signal E1 is split in a first signal processing device DSP1 into a first main signal path HP1 and a first secondary signal path NP1, wherein in the first main signal path HP1, the signal components of the first input signal E1 experience further processing, to be described hereinafter, to form a first output signal A1. The first output signal A1 is converted by an electroacoustic first output transducer L1, which is provided in the present case by a loudspeaker (but can also be provided by a bone vibrator or the like in alternative embodiments (not shown)), into a first output sound signal AS1, wherein the voltage variations of the output signal A1 pass into corresponding air pressure oscillations in the first output sound signal AS1.

In a comparable manner, in the second hearing instrument 2, the second input signal E2 is split in a second signal processing device DSP2 into a second main signal path HP2 and a second secondary signal path NP2, wherein in the second main signal path HP1, the signal components of the second input signal E2 experience further processing to form a second output signal A2. Said second output signal A2 is converted by an electroacoustic second output transducer L2, which is also provided by a loudspeaker, into a second output sound signal AS2.

In the first main signal path HP1, the first input signal E1 is decomposed by means of a first analysis filter bank FA1 into a first plurality N1 of frequency bands FBa-FBz. A first latency T1 for signal components SGa-SGz, generated here, of the first input signal E1 in the respective frequency bands FBa-FBz arises here in the processing of the first input signal E1. In a comparable manner, in the second main signal path HP2, the second input signal E2 is decomposed by means of a second analysis filter bank FA2 into a plurality of frequency bands, which corresponds in the present case to the first plurality N1.

In the first secondary signal path NP1, the first input signal E1 is subjected to a first low-latency analysis 12. For this purpose, the first input signal E1 is divided at a first secondary analysis filter bank FAs1 into a second plurality N2 of frequency bands, wherein the second plurality N2 is less than the first plurality N1 of the frequency bands FBa-FBz of the first analysis filter bank FA1, thus N2<N1. As a result, a second latency T2 arising upon the first low-latency analysis 12 in the processing of the first input signal E1 is less than said first latency T1 of the first analysis filter bank FA1, thus T2<T1. In the first low-latency analysis 12, a first parameter P1 of signal processing of the first input signal E1 is determined on the basis of respective signal components of the first input signal E1 decomposed into the N2 frequency bands. This means in particular that the first parameter P1 is determined such that it is to be applied to a number of signal components SGa-SGz of the first input signal E1 in the respective frequency bands FBa-FBz. The first parameter P1 can be provided in particular here by an amplification factor, a compression ratio and/or a characteristic curve and/or a time constant (“attack” or “release”) of a compression.

In a comparable manner, in the second secondary signal path NP2, the second input signal E2 is subjected to a second low-latency analysis 13. For this purpose, the second input signal E2 is divided at a second secondary analysis filter bank FAs2 into a plurality of frequency bands, which corresponds in the present case to the second plurality N2. Although this represents a preferred embodiment, for alternative embodiments, the number of frequency bands of the second secondary analysis filter bank FAs2 is preferably less than the number of frequency bands of the second analysis filter bank FA2. In the second low-latency analysis 13, a second parameter P2 of signal processing of the second input signal E2 is determined on the basis of respective signal components of the second input signal E2 decomposed by the second secondary analysis filter bank FAs2 into frequency bands. The second parameter P2 preferably specifies the same electronic or physical variable here as the first parameter P1 (thus is preferably also provided by an amplification factor or one of the mentioned variables of the compression) and differs at most in the numeric value from the first parameter. Alternatively thereto, the second parameter P2 permits an inference of an electronic or physical variable equivalent to the first parameter P1 (for example as a signal level or a level peak, on the basis of which an inference of a parameter of a compression is possible).

The first parameter P1 is now transmitted directly after its generation from the first hearing instrument 1 to the second hearing instrument 2 and received there. This is preferably carried out in each case by means of correspondingly suitable communication devices K1, K2 in both hearing instruments 1, 2 (for example, via Bluetooth-capable or NFC-capable antennas or the like). Vice versa, at the same time the second parameter P2 is transmitted from the second hearing instrument 2 to the first hearing instrument 1 and received there. At a point in time which occurs negligibly later after the end of the second latency (thus for practical purposes essentially “with the end of the second latency”, calculated from a specific reference point in time), the first and second parameters P1, P2 are thus locally present in each of the two hearing instruments 1, 2.

In both hearing instruments 1, 2, in the relevant signal processing device DSP1, DSP2, the same algorithm 15 is applied in each case to both parameters P1, P2 together, in order to thus locally determine the same synchronized parameter Ps in each of the two hearing instruments 1, 2. The synchronized parameter Ps is thus formed in other words in the first hearing instrument 1 by a specific mathematical function Ps=Q (P1, P2), which as function arguments maps the first parameter P1 (locally generated in the first hearing instrument 1) and the second parameter P2 (generated in the second hearing instrument 2 and transmitted from there to the first hearing instrument 1) on the synchronized parameter Ps. The same mathematical function Ps=Q (P1, P2) is then also implemented in the second signal processing device DSP2 of the second hearing instrument 2, so that the same value for the synchronized parameter Ps is also determined there on the basis of the two parameters P1, P2 as in the first signal processing device DSP1 of the second hearing instrument 1. The mathematical function Q (P1, P2) can in particular comprise here a maximum value formation, a minimum value formation, a (possibly weighted) averaging, and/or a summation.

In both hearing instruments 1, 2, synchronized parameter Ps (thus having the same value) are now present locally in each case. As a result of the longer first latency T1 in the main signal paths HP1, HP2 than the second latency T2 in the secondary signal paths NP1, NP2, the synchronized parameter Ps, calculated from a reference point in time TR (such as a specific sample or the beginning of a so-called “frame”) is present before the division of a corresponding frame by the first or second analysis filter bank FA1, FA2 is completed. In the selection of the first and second secondary analysis filter bank FAs1, FAs2 or the second plurality N2 of its frequency bands, moreover the transmission time of the first or second parameter P1, P2 to the second or first hearing instrument 2, 1 and the runtime for the algorithm 15 for determining the synchronized parameter Ps was additionally also taken into consideration.

In the exemplary embodiment shown on the basis of FIG. 1, said transmission time TÜ between the hearing instruments 1, 2 and the runtime TL of the algorithm 15 are less than the difference T1-T2 between the first and the second latency. For this reason, in the first secondary signal path NP1, a delay V is also applied to the synchronized parameter Ps, i.e., to ensure an application of the synchronized parameter Ps at the correct point in time with respect to the reference point in time TR to the relevant signal components SGa-SGz in one or some (or also all) frequency bands FB1-FBz in the first main signal path HP1, in the first secondary signal path NP2, in addition to the second latency T2 to the transmission time TU of the second parameter P2 from the second hearing instrument 2 to the first hearing instrument 1 and to the runtime TL of the algorithm 15 (which determines the synchronized parameter Ps), the delay V is applied, so that the synchronized parameter Ps is applied in the first main signal path HP1 with respect to the reference point in time TR precisely after expiration of the first latency T1, thus T1=T2+TÜ+TL+V.

A comparable application of the synchronized parameter Ps takes place in the second main signal path HP2 of the second hearing instrument 2 to signal components of the second input signal E2 (with corresponding delay of the synchronized parameter Ps in the second secondary signal path NP2; not shown).

In an alternative embodiment (not shown in FIG. 1), the delay V is omitted. In such a case, the number of the frequency bands of the second low-latency analysis 13 is preferably selected so that, together with the transmission time TÜ and the runtime TL, it corresponds to the first latency T1, which results from the number of frequency bands into which the first input signal E1 is divided in the first main signal path HP1.

The signal components SGa-SGz of the first input signal E1 in the first main signal path HP1 are compiled after the application 16 of the synchronized parameter Ps (which can be provided, for example, with an amplification factor as the synchronized parameter Ps by simple multiplication of the signal components SGa-SGz in the relevant ones of the frequency bands FBa-FBz) by a first synthesis filter bank FS1 to form the first output signal A1. Any further signal processing steps, whether for the signal components SGa-SGz in the frequency bands FBa-FBz or in the already compiled first output signal A1 are possible in this case, but are not shown in FIG. 1 for reasons of clarity. As already described, the first output signal A1 is converted by the first output transducer L1 into the first output sound signal AS1.

In a comparable manner, in the second main signal path HP2, the signal components of the second input signal E2 in the frequency bands are compiled after the application of the synchronized parameter Ps to the relevant signal components by a second synthesis filter bank FS2 to form the second output signal A2, which is converted by the second output transducer L2 into the second output sound signal AS2.

FIG. 2 schematically shows in a level diagram a course of a signal level of a signal component SGj of the input signal E1 (in a frequency band FBj) according to FIG. 1 and signal processing to be applied to said signal component SGj and synchronized according to FIG. 1 in the form of a signal amplification gj in the frequency band FBj against a time axis t. In the relevant frequency band FBj no noticeable signal level is present up to a point in time T1j. Up to a point in time T0j preceding the point in time T1j, a first maximum output level MPO1 is defined in this case (upper horizontal dashed line), which would result in the case of exceeding it in the compression of the signal component SGj, but has no application in the absence of a signal level before the point in time T0j.

At the point in time T0j a transient is determined in the first secondary signal path NP1 on the basis of a very steep level rise in the time domain, and accordingly a switching value for reducing the first maximum output level MPO1 by a predetermined amount DPO to a second maximum output level MPO2 is determined as the first parameter P1. In the manner described on the basis of FIG. 1, the synchronized parameter Ps is determined from the first parameter P1 and the second parameter P2. It can be assumed here, for example, that the synchronized parameter Ps in the present case then provides said reduction of the first maximum output level MPO1 by the predetermined amount DPO to the second maximum output level MPO2 (switching value 1) when the first or the second parameter P1, P2 provides this (maximum of the respective switching values), for example, to take into consideration that a transient is not identified sufficiently precisely as a result of head shadowing on one side, or the like.

Due to the parameter Ps thus synchronized, at the point in time T0j (the latency in the transmission is to be neglected here in relation to the latency of the first analysis filter bank FA1) the first maximum output level MPO1 is thus reduced by the predetermined amount DPO to the second maximum output level MPO2. As a result of the latency of the first analysis filter bank FA1, the mentioned transient first supplies a contribution Z at the point in time T1j in the frequency band FBj, which now exceeds the second maximum output level MPO2, and is accordingly reduced by the application of a first negative amplification gneg1.

After the end of the transient, at a point in time T2j, the reduction of the maximum output level is canceled again, the first maximum output level MPO1 is now valid again. If, from a point in time T3j, the level of the signal component SGj now steadily exceeds the first maximum output level MPO1, but without a transient being present, the signal component SGj is accordingly reduced by a second negative amplification gneg2.

Although the invention was illustrated and described in more detail by the preferred exemplary embodiment, the invention is not restricted by the disclosed examples and other variations can be derived therefrom by a person skilled in the art without leaving the scope of protection of the invention.

### LIST OF REFERENCE SIGNS

1 first hearing instrument
2 second hearing instrument
10 binaural hearing system
11 ambient sound
12 first low-latency analysis
13 second low-latency analysis
15 algorithm
16 application
A1/2 first/second output signal
AS1/2 first/second output sound signal
DPO predetermined amount
DSP1/2 first/second signal processing device
E1/2 first/second input signal
FA1/2 first/second analysis filter bank
FAs1/2 first/second secondary analysis filter bank
FS1/2 first/second synthesis filter bank
FB1-FBz frequency bands
gj signal amplification (in the frequency band FBj)
gneg1/2 first/second negative amplification
HG1/2 first/second local hearing aid
HP1/2 first/second main signal path
K1/2 communication device
L1/2 first/second output transducer
M1/2 first/second input transducer
MPO1/2 first/second maximum output level
N1/2 first/second plurality
NP1/2 first/second secondary signal path
P1/2 first/second parameter
Ps synchronized parameter
Q mathematical function
SGa-SGz signal components (in the frequency bands)
T1/2 first/second latency
T0j-T3j point in time
TL runtime (of the algorithm)
TR reference point in time
TÜ transmission time
Z contribution (of the transient in the frequency band FBj)

1-12. (canceled)

13. A method for operating a binaural hearing system, the method comprising:
providing a first hearing instrument having a first input transducer;
providing a second hearing instrument having a second input transducer;
using the first input transducer to generate a first input signal from an ambient sound, and using the second input transducer to generate a second input signal from the ambient sound;
subjecting the first input signal to a first low-latency analysis to determine at least one first parameter of a signal processing;
subjecting the second input signal to a second low-latency analysis to determine a second parameter of a signal processing;
transmitting the first parameter to the second hearing instrument and transmitting the second parameter to the first hearing instrument;
determining a synchronized parameter in each of the first and second hearing instruments based on the respective first and second parameters; and
applying the synchronized parameter in the first hearing instrument to signal components of the first input signal, and applying the synchronized parameter in the second hearing instrument to signal components of the second input signal.

14. The method according to claim 13, which further comprises:
dividing the first input signal in a first main signal path into a plurality of frequency bands to generate frequency band components of the first input signal; and
applying the synchronized parameter in the first main signal path to the frequency band components as the signal components of the first input signal or applying the synchronized parameter to signal components derived from the frequency band components.

15. The method according to claim 14, which further comprises providing at least one of the first or second low-latency analysis by an analysis in a time domain or an analysis in a frequency domain or a time-frequency domain with a smaller number of frequency bands than the plurality of frequency bands in the first main signal path or a corresponding second main signal path of the second hearing instrument.

16. The method according to claim 15, which further comprises at least compensating for a second latency of the second low-latency analysis and a transmission time of the second parameter from the second hearing instrument to the first hearing instrument by a first latency of the division of the first input signal into the plurality of frequency bands in the first main signal path.

17. The method according to claim 13, which further comprises applying a delay between a reception of the second parameter of the second hearing instrument by the first hearing instrument and the application of the synchronized parameter to the signal components of the first input signal.

18. The method according to claim 16, which further comprises selecting a number of the frequency bands of the second low-latency analysis to cause the second latency of the second low-latency analysis and the transmission time to correspond together to the first latency of the division of the first input signal into the plurality of frequency bands in the first main signal path.

19. The method according to claim 13, which further comprises determining the synchronized parameter based on the first parameter and the second parameter by using at least one of a maximum value or a minimum value or averaging or summation.

20. The method according to claim 14, which further comprises:
detecting a transient in at least one of the first low-latency analysis or the second low-latency analysis; and
determining, based on a detected transient, a switching value for a level reduction in the first main signal path by a predetermined amount as the first parameter or second parameter.

21. The method according to claim 20, which further comprises determining the transient in the first low-latency analysis or in the second low-latency analysis by using an identification of a level increase of a predetermined minimum slope.

22. The method according to claim 20, which further comprises additionally carrying out the level reduction by the predetermined amount in the first main signal path in each of the plurality of frequency bands based on the respective signal components.

23. A binaural hearing system, comprising:
a first hearing instrument having at least one first input transducer; and
a second hearing instrument having at least one second input transducer;
the binaural hearing system being configured to carry out the method according to claim 13.

24. The binaural hearing system according to claim 23, wherein the binaural hearing system is a binaural hearing aid, said first hearing instrument is a first local hearing aid and said second hearing instrument is a second local hearing aid.
